(19) United States
(12) Patent Application Publication
(10) Pub. No.: US 2007/0289918 A1
(43) Pub. Date: Dec. 20, 2007

(54) WATER FILTER CARTRIDGE FOR A WATER TANK

(76) Inventors: Petra STAIGER, Kerns (CH); Peter Kathriner, Sarnen (CH)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/759,258

(22) Filed: Jun. 7, 2007

(30) Foreign Application Priority Data
Jun. 14, 2006 (EP) 06 405 257.4

(51) Int. Cl. B01D 27/00

(52) U.S. Cl. 210/440

(57) ABSTRACT

The water filter cartridge according to the invention for a beverage machine with a water tank comprehends a housing (2, 3), which has an adapter seat (3.1), and an adapter (5) for a connecting nozzel (22′;22″) of the water tank (20′;20″), wherein the adapter (5) can be fitted into the adapter seat (3.1) of the housing (2, 3).

### TECHNICAL FIELD

The invention relates to a water filter cartridge for a water tank and to a beverage machine with water tank and water filter cartridge.

Water filter cartridges are built into water tanks of beverage machines to treat the water located in the water tank. By using the water filter cartridge, the liquid led through the filter cartridge, for example drinking water, can be demineralised and decarbonised. In addition, fine particles can be filtered out. A connector is located into the water tank and the filter cartridge can be fitted on the connector and the treated water can be removed from the water tank through this connector. The beverage machine preferably has a suction pump for drawing the water through the filter cartridge.

### BACKGROUND OF THE INVENTION

A filter cartridge is known from the prior art WO 2006/040121 A1 and EP 1 340 442 B1 respectively, wherein the intake area for the water to be filtered and the outlet opening for the filtered water are arranged in the bottom area of the filter cartridge. An upflow chamber is connected to the intake area and, in turn, a downflow chamber is connected to the upflow chamber, whereas both chambers are interconnected in the upper area of the filter cartridge.

Depending on the manufacturer of the beverage machine the connector located in the water tank-to which the filter cartridge is to be connected and through which the treated water can be removed from the water tank-can be of varying designs. So far these connectors have not been standardised, the result of which is that a filter cartridge cannot be fitted onto just any connector. Instead, it is necessary to build a separate filter cartridge for each connector type. This increases logistical expenditures related to stockpiling and making available filter cartridges.

### SUMMARY OF THE INVENTION

An object of the invention is to provide a water filter cartridge for a water tank, which is configured in such a way that it can be used for different water tanks, which possess differently designed connecting nozzels.

The object is solved by a water filter cartridge for a water tank having the characteristics of claim 1.

The water filter cartridge according to the invention for a beverage machine with a water tank comprises a housing, which has an adapter seat, and an adapter for a connecting nozzel of the water tank, wherein the adapter can be fitted into the adapter seat of the housing.

Advantageous further developments of the invention will emerge from the characteristics specified in the dependent claims.

In a further development of the water filter cartridge according to the invention the adapter has two differently designed connecting nozzels. This allows the filter cartridge to be connected via a single adapter to two different water tank connectors.

In another further development of the water filter cartridge according to the invention the adapter can be fitted into two different fitting positions in the adapter seat of the housing. The housing can be connected to a connector of the water tank having a first structural form through the adapter in its first fitting position. The housing can be connected to a connector of the water tank having a second structural form through the adapter in its second fitting position.

In an embodiment of the water filter cartridge according to the invention, the adapter seat is arranged inside the housing. The adapter can thus be lowered into the cartridge and the available structural space can thus be utilised optimally.

In another embodiment of the water filter cartridge according to the invention the adapter can be removed. In this way the cartridge can be fitted, at any time, with another adapter.

The first connecting nozzel of the adapter in longitudinal direction has, advantageously, several ribs, ensuring a secure and stable seating of the adapter in the connector of the water tank.

It is also an advantage if, in the case of the water filter cartridge, the first connecting nozzel of the adapter has an annular rib. This guarantees that the adapter is securely held in the adapter seat of the filter cartridge.

In addition, in the case of water filter cartridge, the first connecting nozzel of the adapter can have a seal in the opening area. The result is that the now treated water can no longer flow back into the water tank.

To solve the task it is also proposed that, in the case of the water filter cartridge, the second connecting nozzel of the adapter has an elastic ring on the outside. This guarantees that the adapter is securely held in the adapter seat, if the first connecting nozzel is used for connecting the filter cartridge to the water tank.

In the case of the water filter cartridge, according to a further characteristic of the invention, the second connecting nozzel of the adapter can have a sealing ring on the outside. This prevents the treated water from flowing back into the water tank.

In the case of the water filter cartridge the adapter can have a thread, which is used to screw the adapter onto the connector of the water tank. At least one seal can in this way be omitted.

With the water filter cartridge according to the invention, the connection between the adapter and the housing can be designed in such a way that, after the adapter has been connected to the housing, the connection can no longer be separated.

In a further development of the water filter cartridge a sieve is provided in the bottom area of the housing. This can be used to fill the cartridge up to the bottom of the cartridge with filter material and the water to be treated can also still be suctioned out in proximity of the bottom of the water tank.

In accordance with another characteristic of the invention the water filter cartridge has a section, in which the water rises and a downpipe, which is connected to this section. The cartridge can accordingly be compactly built and makes optimal use of the available space in the water tank. In addition, a cartridge designed accordingly is particularly well suited to a high water tank.

In an embodiment of the water filter cartridge filter material is provided in the section, in which the water rises.

In another embodiment of the water filter cartridge a sieve is arranged between the section and the down pipe. This prevents filter material entering into the down pipe.

Radially running links are advantageously provided in the housing of the water filter cartridge and they enclose the down pipe. The links stabilise the down pipe and can also be used to hold the sieve firmly on the down pipe. The links also ensure that the filter material remains distributed uniformly in the cartridge.

In addition to this, the housing of the water filter cartridge can have a lower housing part and an upper housing part, wherein the adapter seat is part of the lower housing part. This is an advantage in particular for manufacturing the cartridge in the injection moulding process.

In addition, a beverage machine can be provided with a suction pump and with the above described water filter cartridge.

Finally, the water filter cartridge can be used in a beverage machine.

### BRIEF DESCRIPTION OF THE DRAWINGS

The invention is explained in greater detail hereinafter with reference to several embodiments by means of 12 FIGS.

FIG. 1 shows a three-dimensional view of the water filter cartridge according to the invention, which is prepared for a water tank with a first connector type.

FIG. 2 shows a section through the water filter cartridge according to the invention and a part of the water tank with the first connector type.

FIG. 3 shows a three-dimensional view of the water filter cartridge according to the invention, which is prepared for a water tank with a second connector type.

FIG. 4 shows a section through the water filter cartridge according to the invention and a part of the water tank with the second connector type.

FIG. 5 shows a three-dimensional view of the water filter cartridge according to the invention without the adapter for the connector to the water tank.

FIG. 6 shows a section through the water filter cartridge according to the invention without the adapter for the connector to the water tank.

FIG. 7 shows a further three-dimensional view of the water filter cartridge according to the invention.

FIG. 8 shows a three-dimensional view of the water filter cartridge according to the invention without the cover.

FIG. 9 shows a three-dimensional view of the adapter of the water filter cartridge according to the invention.

FIG. 10 shows the adapter in a cross-section.

FIG. 11 shows a further embodiment of the adapter in a side view.

FIG. 12 shows the further embodiment of the adapter in a cross-section.

### WAYS FOR IMPLEMENTING THE INVENTION

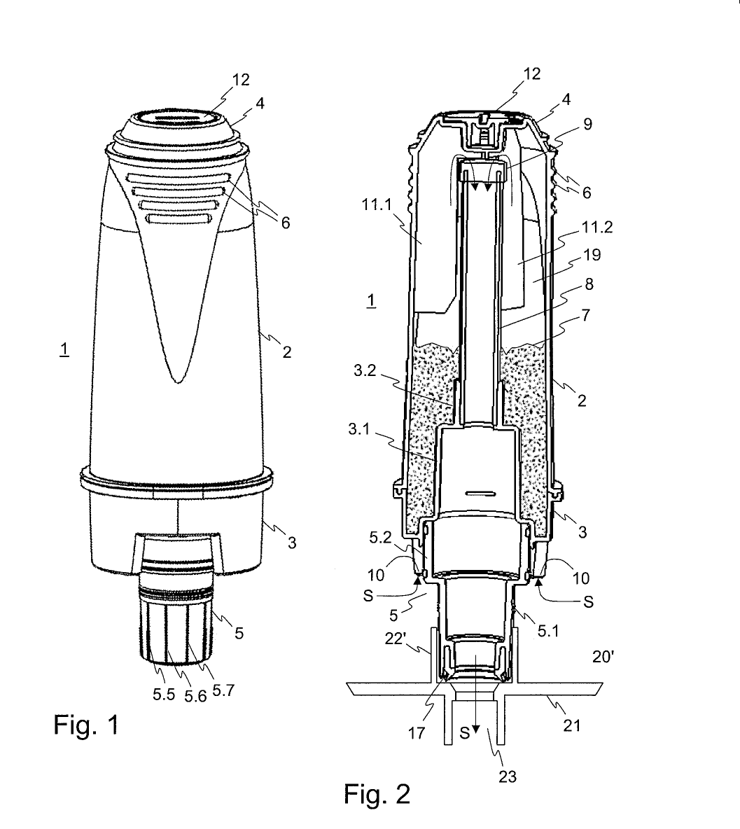

FIG. 1 shows a three-dimensional view of the water filter cartridge 1 according to the invention, which is prepared for a water tank 20′ with a first connector type. The water filter cartridge 1, also designated hereinafter as a filter cartridge, comprises an upper housing part 2 and a lower housing part 3, which are connected to one another for example by gluing, welding or by means of a snap connection. The connection point is sealed in order to prevent the filter material 7, which is located inside the filter cartridge 1, from escaping. Both housing parts 2 and 3 are in each case made of synthetic material respectively as a monobloc injection-moulded part. The cover 4 is a constituent of the upper housing part 2. Several substantially horizontally aligned ribs 6 are arranged in the upper area of the upper housing part 2, in order to securely hold the filter cartridge 1. An adapter 5 protrudes from the lower housing part 3 and the filter cartridge 1 can be connected to the connector 22′ of a water tank 20′ through the lower connector piece 5.1 of this adapter 5.

FIG. 2 shows a section through the water filter cartridge 1 according to the invention, wherein the adapter 5 is in the same fitting position as in FIG. 1. As already mentioned, the filter cartridge 1 is prepared for a water tank 20′ with a first connector type. The connector 22′ is located on the bottom 21 of the water tank 20′ and is schematically displayed in FIG. 2. The first connecting nozzel 5.1 of the adapter 5 protrudes into the connector 22′ and forms with the latter a positive locking connection and a force locking connection. For this purpose, the connecting nozzel 5.1 has on its outside several ribs running in a longitudinal direction and parallel to one another, whereby FIG. 1 identifies only the ribs 5.5, 5.6 and 5.7. Preferably, the ribs on the casing surface of the connecting nozzel 5.1 are distributed equidistantly. The diameters of the first connecting nozzel 5.1 and the ribs are of such dimensions that they form light mechanical resistance when the filter cartridge 1 is fastened to the connector 22′, and accordingly provide a secure and stable hold for the adapter 5 in the connector 22′. To prevent already filtered water from flowing back into the water tank 20′, an elastic, annular seal 17 is located at the end of the first connecting nozzel 5.1. The seal 17 protrudes backwards into a groove, which is formed by an inner wall 5.8 and the wall of the first connecting nozzel 5.1. The seal 17 has, at its downstream end, an annular lip, which is pressed against the bottom 21 of the water tank 20′ in the installed state.

Attached to the outlet 23 of the water tank 20′is a duct with a suction pump for suctioning the water out of the filter cartridge 1. Such duct with suction pump is not shown in the FIGS. The direction of flow of the water is indicated by arrows and reference numeral S. The water filter cartridge 1 according to the invention can also be operated without a suction pump. If for example the water level in the water tank is situated above the intake opening of the downpipe 8, the dynamic pressure of the water already ensures that the water to be treated by the filter cartridge 1 is flowing. It is also possible to connect the filter cartridge directly or indirectly to a pressure water piping, so that the water to be treated by the filter cartridge is pressurised. A house water pipe can act as pressure water piping, for example.

A central downpipe 8 is located inside the housing 2, 3 and the upper opening of this central downpipe is covered by a sieve 9 and the lower opening of this central downpipe terminates in a seat 3.2 of the lower housing part 3. Located in the region between the outside of the downpipe 8 and the inner wall of the housing 2, 3 is a granular filter material 7. This region is designated hereinafter also as section or riser. In particular if the filter material 7 becomes wet it can swell. In order to prevent the housing 2, 3 of the filter cartridge 1 from deforming due to an increase in volume of the filter material 7, this area of the filter cartridge 1 is preferably not filled completely with filter material 7. Rather, an empty space in the cartridge 1, which serves as a buffer zone for a change in volume of the filter material 7, remains after the cartridge 1 is filled.

Sieves 10 are located in the bottom region of the filter cartridge 1 for holding back the granular filter material 7. The sieves 10 can be designed as grilles, meshes or slots. A fleece or a woven fabric may also serve as a sieve 10. The mesh width of the sieves 10 matches the granulation of the filter material 7 and is preferably in the range of 0.1 mm to 0.4 mm. The sieves 10 can also have holes with openings in the range of 0.1 mm to 0.4 mm, instead of mesh. The sieves 10 can be pressed in or moulded. The same applies correspondingly for the sieve 9.

In addition, one or more links 11.1, 11.2 and 11.3 can also be provided inside the water filter cartridge 1 according to the invention. In the embodiment shown in FIG. 2 the links 11.1, 11.2 and 11.3 are formed on the upper housing part 2. The central downpipe 8, designated hereinafter also as downpipe, is kept in its position by means of links 11.1, 11.2 and 11.3 and ensures uniform distribution of the filter material 7.

The water treatment occurs with the aid of the granular or grained filter material 7. A mixture of ion exchangers and active carbon can serve as filter material 7 for the water filter cartridge 1 according to the invention.

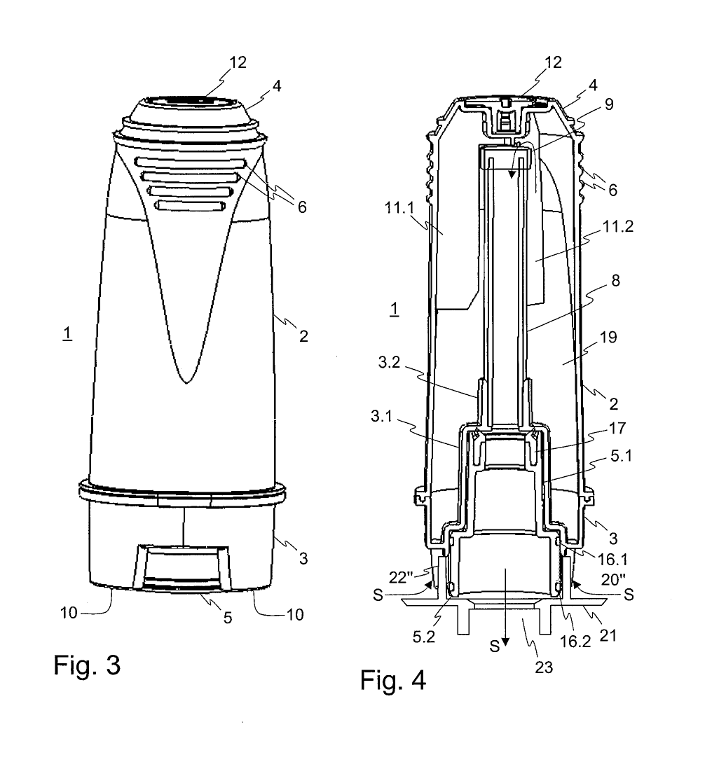

FIG. 3 shows a three-dimensional view and FIG. 4 shows a section through the water filter cartridge 1 according to the invention, whereby the water filter cartridge 1 is now prepared for a water tank 20″ with a second connector type 22″. The assemblage of the filter cartridge 1 does not differ from the embodiment shown in FIGS. 1 and 2. For the sake of clarity the filling of the cartridge 1 with filter material 7 is not shown in FIG. 4. The water tank 20″ differs from the water tank 20″ by a connector 22″ which is formed differently compared to the connector 22′. The connector 22″ has a larger diameter than the connector 22′. The second connecting nozzel 5.2 of the adapter 5 is used to connect the filter cartridge 1 to the connector 22″. For this purpose the adapter 5 is fitted into the adapter seat 3.1 of the cartridge 1 in such a way that the connecting nozzel 5.2 protrudes on underside of the cartridge 1. The connecting nozzel 5.2 of the adapter 5 protrudes into the connector 22″ and forms with the latter a positive locking connection and a force locking connection. The connecting nozzel 5.2 has on its outside a first seal 16.1 and a second seal 16.2. The junction between the connecting nozzel 5.2 and the connector 22″ is sealed and secured by means of the seal 16.2, in such a way that the treated water does not flow back into the water tank 20″. The seal 16.1 and both annular ribs 5.3 and 5.4 ensure that the adapter 5 sits firmly in the seat 3.1 and that the cartridge 1 does not accidentally slip out. In the fitting position shown in FIG. 4 the annular lip of the seal 17 is pressed against the adapter seat 3.1. The seal 16.2 and the seal 17 both prevent the treated water from flowing back into the water tank 20″.

To put the filter cartridge 1 into operation it is first ascertained which of the two connecting nozzels 5.1 or 5.2 of the adapter 5 fits the connector 22′/22″ of the water tank 20′/20″ and the adapter 5 is then placed in the adapter seat 3.1 of the housing 2, 3 of the filter cartridge 1 in such a way that the matching connecting nozzel 5.1 or respectively 5.2 protrudes from the lower housing part 3. In a second step the filter cartridge 1 is set onto the connector 22′ or 22″ of the water tank 20′ or respectively the water tank 20″. Then, the filter cartridge 1 is mounted and ready for use in the water tank of the beverage machine.

When operating, the suction pump of the beverage machine suctions water from the filter cartridge 1. At the same time the water to be filtered flows out of the water tank 20′ or respectively 20″ through the sieves 10 arranged in the bottom area of the filter cartridge 1 upwards through the filter material 7 and is treated in the process. Next, the treated water flows through the sieve 9 and reaches the outlet 23 via the downpipe 8.

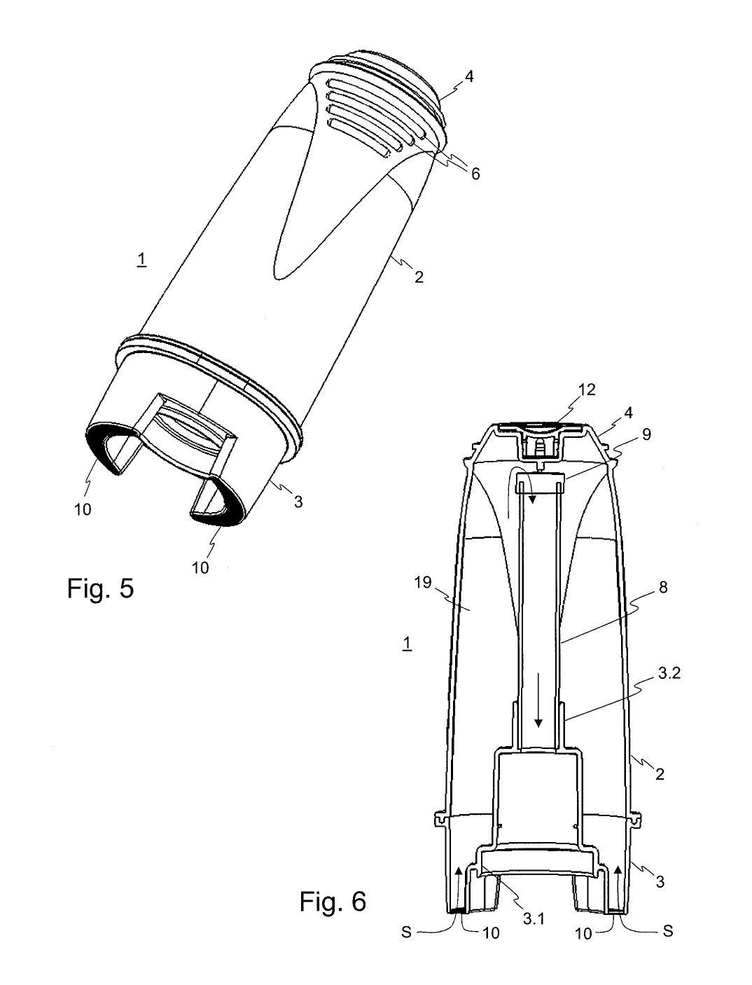

FIG. 5 shows a three-dimensional view of the filter cartridge 1 according to the invention without the adapter 5.

FIG. 6 shows a section through the filter cartridge 1 according to the invention without the adapter 5 and without the filter material 7.

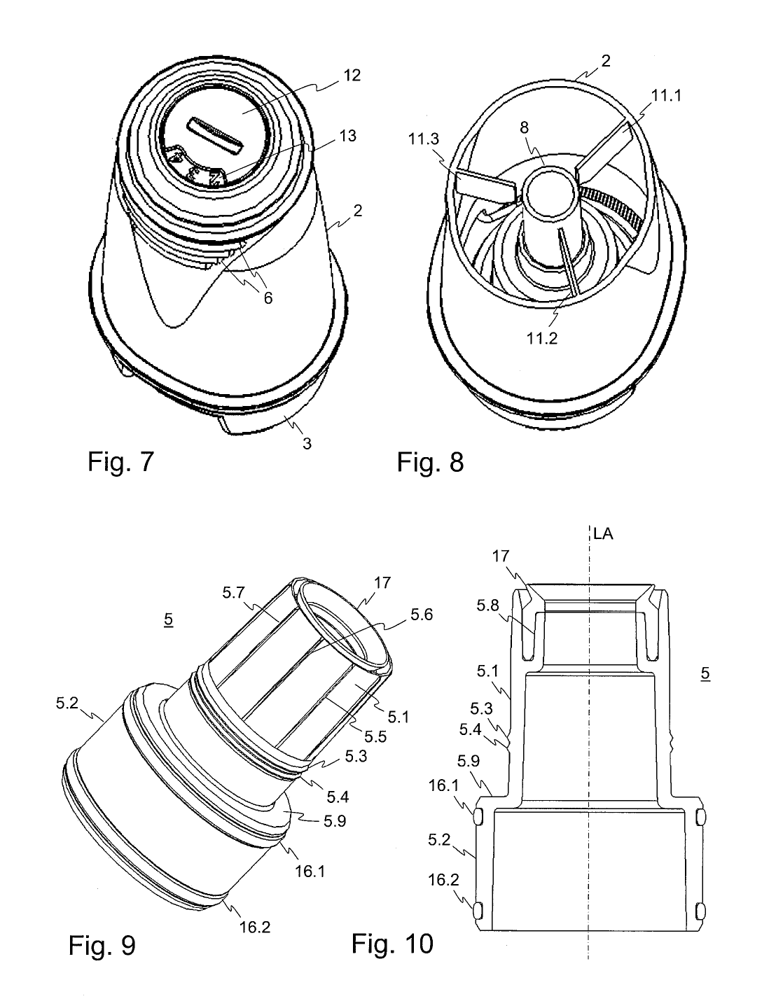

As we can gather from FIG. 7, the numerals 1 to 12, acting as monthly designation, are to be found on the cover 4. In addition, a rotary disk 12 with a viewing window 13 is arranged on the cover 4, whereby the number indicated in the viewing window 13 signals when the filter cartridge is used and when it should be replaced by a new cartridge. In the embodiment illustrated in FIG. 7 the rotary disc 12 is adjusted in such a way that the numerals 2, 3 and 4 are to be perceived in the viewing window 13.

FIG. 8 shows a three-dimensional view of the water filter cartridge 1 according to the invention without the cover 4.

FIG. 9 shows a three-dimensional view of the adapter 5 of the filter cartridge 1 according to the invention.

FIG. 10 shows the adapter 5 in cross-section. The junction from the first connecting nozzel 5.1 to the second connecting nozzel 5.2 is formed by the shoulder 5.9.

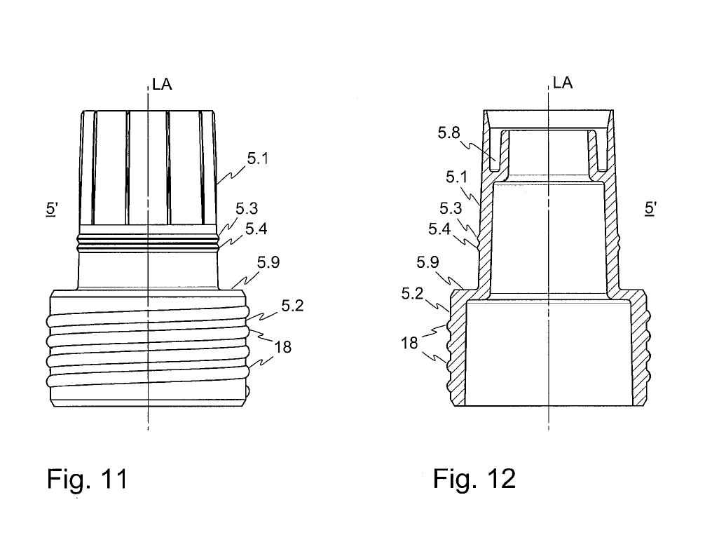

In case the connector 22 of the water tank 20 has an internal thread, an adapter 5′ can be used, which is configured as shown in FIGS. 11 and 12. In FIG. 11 the adapter 5′ is illustrated in a side view and in FIG. 12 in a cross-section. The adapter 5′ differs from the adapter 5 shown in FIGS. 9 and 10 by the fact that the adapter 5′ has a thread 18 on the outside of the second connecting piece 5.2 instead of both sealing rings 16.1 and 16.2. The thread can, if necessary, also be arranged on the outside of the first connecting piece 5.1.

In the event where the connector 22 of the water tank 20 has an external thread, the adapter 5′ can have a correspondingly formed thread on the inside of the second connecting piece 5.2. The thread can, if necessary, also be arranged on the inside of the first connecting piece 5.1.

Instead of this the adapter 5 can also be fitted with a bayonet joint or a snap connection. The adapter can also have a thread on one connection piece and a bayonet joint on the other connector piece. The adapter can have a combination of different types of connectors.

The adapter 5 can be designed in such a way that as soon as the adapter is connected to the housing 3 of the filter cartridge 1, it can no longer be separated from the housing 3. This can be done for example using a snap connection which cannot be any more detached. In this way the filter cartridge can be delivered with a properly factory-fitted adapter. The end user does not need then any more to check which side of the adapter matches the connector of the water tank.

The cross-section of the adapter matches the structural conditions of the connector of the water tank. If the water tank 20 has for example a connector 22 with a rectangular cross-section, then one of the two connecting pieces of the adapter can likewise have a corresponding rectangular cross-section.

The filter cartridge 1 can be used in private households, for example in domestic appliances and machines such as coffee makers, tea machines, soft drink machines, juice extractors, irons, dishwashers, washing machines, water purifiers and water dispensers, in humidifiers and air purifiers. The water filter cartridge can also be used in machines in the gastronomy sector.

Another embodiment of the filter cartridge according to the invention is described hereinafter. The adapter seat 3.1 of the filter cartridge 1 can be designed in such a way that it itself acts as coupling to the connector 22″ of the water tank 20″. In this case the adapter 5 can be omitted. If the filter cartridge 1 is however to be fitted onto the connector 22′ of the water tank 20′, an adapter, which then forms the appropriate coupling to the connector 22′, can be fitted in the adapter seat 3.1.

The preceding description of the embodiments according to the present invention is used only for illustrative purposes and not for the purpose of restricting the invention. Different alterations and modifications are possible within the framework of the invention without leaving the scope of the invention and its equivalents.

### REFERENCE SIGNS

1 Water filter cartridge
2 Upper housing part
3 Lower housing part
3.1 Seat for the adapter
3.2 Seat for the downpipe
4 Cover
5 Adapter
5.1 First connecting piece
5.2 Second connecting piece
5.3 First annular rib
5.4 Second annular rib
5.5-5.7 Longitudinal ribs
5.8 Inner wall
5.9 Shoulder
6 Ribs
7 Filter material
8 Downpipe
9 Sieve
10 Sieve
11.1-11.3 Links
12 Rotary disk
13 Viewing window
16.1 Sealing rings
16.2 Sealing rings
17 Seal
18 Thread
19 Section or chamber
20′ Water tank
20″ Water tank
21 Bottom
22′ Connector
22″ Connector
23 Outlet
S Direction of flow
LA Longitudinal axis

1. A water filter cartridge for a water tank, comprising: a housing, which has an adapter seat, and an adapter for a connecting nozzel of the water tank, wherein the adapter can be fitted into the adapter seat of the housing.

2. A water filter cartridge according to claim 1, wherein the adapter has two connecting nozzels of varying design.

3. A water filter cartridge according to claim 1 or
wherein the adapter can be fitted into the adapter seat of the housing in two different fitting positions,
wherein the housing can be connected to a connector of the water tank, which has a first structural form, via the adapter in its first fitting position, and
wherein the housing can be connected to a connector of the water tank, which has a second structural form, via the adapter in its second fitting position.

4. A water filter cartridge according to claim 1, wherein the adapter seat is arranged inside the housing.

5. A water filter cartridge according to claim 1, wherein the adapter can be removed.

6. A water filter cartridge according to claim 1, wherein the first connecting nozzel of the adapter has several ribs in the longitudinal direction.

7. A water filter cartridge according to claim 1, wherein the first connecting nozzel of the adapter has an annular rib.

8. A water filter cartridge according to claim 1, wherein the first connecting nozzel of the adapter has a seal in the opening area.

9. A water filter cartridge according to claim 1, wherein the second connecting nozzel of the adapter has an elastic ring on the out-side.

10. A water filter cartridge according to claim 1, wherein the second connecting nozzel of the adapter has a sealing ring on the outside.

11. A water filter cartridge according to claim 1, wherein the adapter has a thread.

12. A water filter cartridge according to claim 1, wherein the adapter can be connected to the housing, wherein the connection cannot be any more separated.

13. A water filter cartridge according to claim 1, wherein a sieve is provided in the bottom area of the housing.

14. A water filter cartridge according to claim 1,
with a section in which the water rises, and
with a downpipe connected thereto.

15. A water filter cartridge according to claim 14, wherein filter material is provided in the section.

16. A water filter cartridge according to claim 14, wherein a sieve is arranged between the section and the downpipe.

17. A water filter cartridge according to claim 14, wherein radially running links, which enclose the downpipe, are provided in the housing.

18. A water filter cartridge according to claim 1, wherein the housing has a lower housing part and an upper housing part, wherein the adapter seat is part of the lower housing part

19. A beverage machine with a water filter cartridge according to claim 1, wherein a suction pump is provided.

20. A method comprising using the water filter cartridge according claim 1 in a beverage machine.
